(19) United States
(12) Patent Application Publication
(10) Pub. No.: US 2004/0258388 A1
(43) Pub. Date: Dec. 23, 2004

(54) Optical fiber sewing machine and manufacturing method of products produced using it

(76) Inventors: Tae-Young Kim, Chungcheonbuk-do (KR); Jae-Wook Park, Seoul (KR)

Correspondence Address: BIRCH STEWART KOLASCH & BIRCH, PO BOX 747, FALLS CHURCH, VA, 22040-0747, US

(21) Appl. No.: 10/490,640

(22) PCT Filed: Sep. 26, 2002
(86) PCT No.: PCT/KR02/01814

(30) Foreign Application Priority Data
Sep. 28, 2001 (KR) 2001/29932
Sep. 28, 2001 (KR) 2001/29933
Sep. 28, 2001 (KR) 2001/29934
Sep. 24, 2002 (KR) 2002/57695

(51) Int. Cl. G02B 6/00

(52) U.S. Cl. 385/147

(57) ABSTRACT

The invention relates to an optical fiber sewing apparatus for sewing optical fibers into a material workpiece and the methods of manufacturing the products using the optical fiber sewing apparatus.

According to the present invention, the optical fiber sewing apparatus comprises comprising; a fixed plate 50 which is fixed to the lower section of said sewing head 20; a pushing plate 60 which is fixed on upper section of said fixed plate 50 wherein said pushing plate 60 is moved up and down by a pushing plate transfer cylinder 61 and said pushing plate further comprises a insertion groove 63 to which a needle holder 31 is inserted and a guide pipe 64 is constructed at the lower section of said insertion groove 63; a cutter 70 which cuts the optical fibers 5 and located at the lower section of said fixed plate 50 wherein said cutter 70 moves on a horizontal direction by a cutter cylinder 71 in order to cut the optical fibers 5; a material workpiece table 100 which is located at the lower section of said cutter 70 in order to support a material workpiece 9 with a plurality of supporting blades 120; and wherein said optical fibers 5 is provided through the eye of the needle 30 from a optical fiber spool via a tension control section 10 and elastic body 6.

The optical fiber sewing apparatus according to the present invention, the optical fibers are more precisely sewed onto the material workpiece, the optical fibers are provided without being entangled and the material workpiece is not lifted when the needle is removed.

### BACKGROUND OF THE INVENTION

1. Field of the Invention

The invention relates to an optical fiber sewing apparatus for sewing optical fibers into a material workpiece and the methods of manufacturing the products using the optical fiber sewing apparatus. More specifically, the invention relates to an optical fiber sewing apparatus and the methods of manufacturing the products using the same through which the optical fibers are more precisely sewed onto a material workpiece, and the optical fibers are provided without being entangled and the material workpiece is not lifted when the needle is removed.

2. Related Prior Art

This application is an improvement over the previously filed applications in Korea, No.2001/29932(Patent No. 264293), No.2001/29933 (Patent No. 264294) and No. 2001/29934(Patent No. 264295).

The prior art discloses the optical fibers which are firmly sewed onto a material workpiece, which might be composed of the natural fibers such as cotton and leather or synthetic fibers. With some parts of the front end of the optical fibers protruding from the material workpiece in a specific letter designs or patterns, light is transmitted from the front end of the optical fibers in order to illuminate the designed letter or patterns producing a stage effect.

In order to attain the above effect, first of all, a large amount of optical fibers should be sewed onto a material workpiece without falling off. This was made possible through an optical fiber sewing apparatus in which optical fibers are provided through the eye of a needle when the needle has pierced through a material workpiece and then the optical fibers should be cut after the needle is removed from the material workpiece.

A head which provides optical fibers through the eye of a needle is able to move on a table in X and Y directions so as to sew the optical fibers freely on a material workpiece. However, it is difficult to represent the exact shape of a letter or pattern since the optical fibers could not be sewed precisely onto the required position. This is due to the material workpiece which is lifted along with the needle when the needle is removed from the material workpiece.

Also, a large amount of loads are applied to the supply of optical fibers since the head moves rapidly along the patterns on the material workpiece. This rapid head movement causes failures since the length of the optical fibers become irregular or excessively supplied optical fibers become entangled.

In order to pierce through the material workpiece with the needle with an eye and to sew the optical fibers precisely as required, the lower section of the material workpiece must be supported. However, it is not easy to provide a support without blocking the needle which pierces through the material workpiece.

### SUMMARY OF THE INVENTION

The present invention is designed to overcome the above problems of prior art. The first object of the present invention is to prevent a material workpiece being lifted along with a needle when the needle is removed from the material workpiece by lowering a pushing plate, which could move up and down, in order to hold the material workpiece while the needle is piercing through the material workpiece and the needle is being supplied with optical fibers as well as while the needle is being removed and the pushing plate is returning to its original position.

The second object of the present invention is to maintain a fixed length of the optical fibers which pierce through the material workpiece by maintaining a fixed tension on the optical fibers until the optical fibers are provided to the eye of the needle by the roller of a head after the optical fibers have been unreeled from a spool.

The third object of the present invention is to prevent crumpling of the material workpiece as well as damages to the supporting blades or needle by supporting the material workpiece with a plurality of supporting blades which are spaced apart at a fixed length on a thin plate underneath the material workpiece and allowing the supporting blades to bend to left or right in order to avoid blocking of the needle when the needle touches the supporting blades.

The fourth object of the present invention is to prevent any damages to the needle or supporting blades by constructing a plurality of supporting blades to stop the crumpling of the material workpiece and allowing the supporting blades to bend to left or right in order to avoid blocking of the needle when the needle touches the supporting blades.

The fourth object of the present invention is to provide an optical fiber sewing apparatus and the methods of manufacturing the products which could significantly improve the quality and reliability of the products.

In order to achieve the above objects, an optical fiber sewing apparatus according to the present invention wherein said apparatus comprises a needle transfer cylinder 33 that moves the needle 33 with an eye up and down directions, a sewing head 20 that further comprises a transfer roller 40 which provides a fixed length of optical fibers through the eye of the needle and moves in X and Y directions, an improvement of said apparatus, comprising a fixed plate 50 which is fixed to the lower section of said sewing head 20; a pushing plate 60 which is fixed on the upper section of said fixed plate 50 wherein said pushing plate 60 is moved up and down by a pushing plate transfer cylinder 61 and said pushing plate further comprises a insertion groove 63 to which a needle holder 31 is inserted and a guide pipe 64 is constructed at the lower section of said insertion groove 63; a cutter 70 which cuts the optical fibers 5 and is located at the lower section of said fixed plate 50 wherein said cutter 70 moves on a horizontal direction by a cutter cylinder 71 in order to cut the optical fibers 5; a material workpiece table 100 which is located at the lower section of said cutter 70 in order to support the material workpiece 9 with a plurality of supporting blades 120; and wherein said optical fibers 5 are provided to the eye of the needle 30 from a optical fiber spool via a tension control section 10 and an elastic body 6.

### BRIEF DESCRIPTION OF THE DRAWINGS

FIG. 1 is a perspective view of the optical fiber sewing apparatus according to the present invention.

FIG. 2 is a perspective view of the head of the optical fiber sewing apparatus according to the present invention.

FIG. 3 is a cross section view of the transfer roller power transfer status of the optical fiber sewing apparatus according to the present invention.

FIG. 4 is a cross section view of the pushing plate before operation according to the present invention.

FIG. 5 is a cross section view of a lowered state of the pushing plate according to the present invention.

FIG. 6 is a cross section view of a lowered state of the needle according to the present invention.

FIG. 7 is a perspective view of the essential parts according to the present invention.

FIG. 8 is a cross section view of the transfer pipe and needle according to the present invention.

FIG. 9 is a perspective view of a gear assembly of the power transfer roller according to the present invention.

FIG. 10 is a plan view of the transfer roller according to the present invention.

FIG. 11 is a cross section view of the cutter in operation according to the present invention.

FIG. 12 is a perspective view of the material workpiece table according to the present invention.

FIG. 13 is a perspective view of the material workpiece table in operation according to the present invention.

FIG. 14 is a plan view of the optical fiber spool according to the present invention.

FIG. 15 is a plan view of some parts of the tension control section according to the present invention.

FIG. 16 is a cross section view of the elastic body in operation according to the present invention

FIG. 17 is a magnified cross section view of the construction and some parts of the products manufactured by the optical fiber sewing apparatus according to the present invention.

### DETAILED DESCRIPTION OF THE PREFERRED EMBODIMENTS

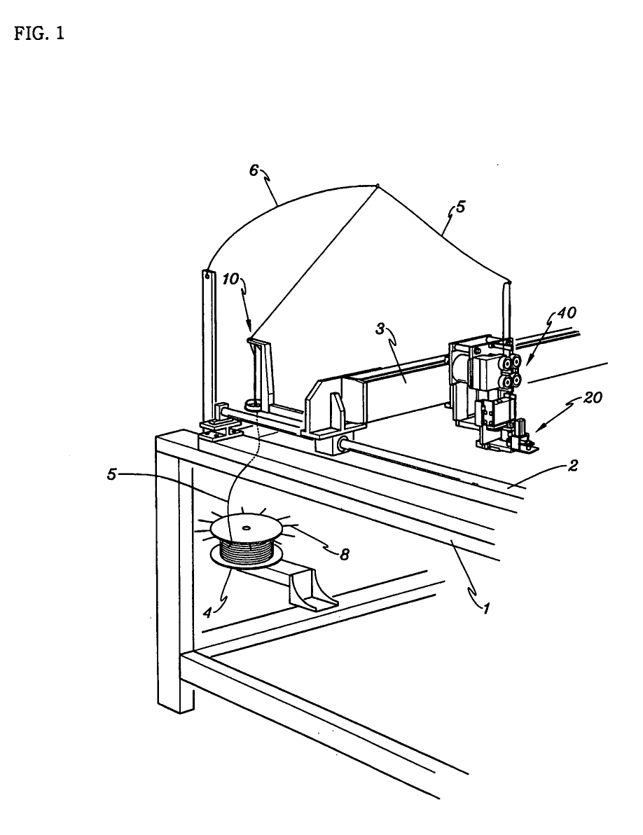

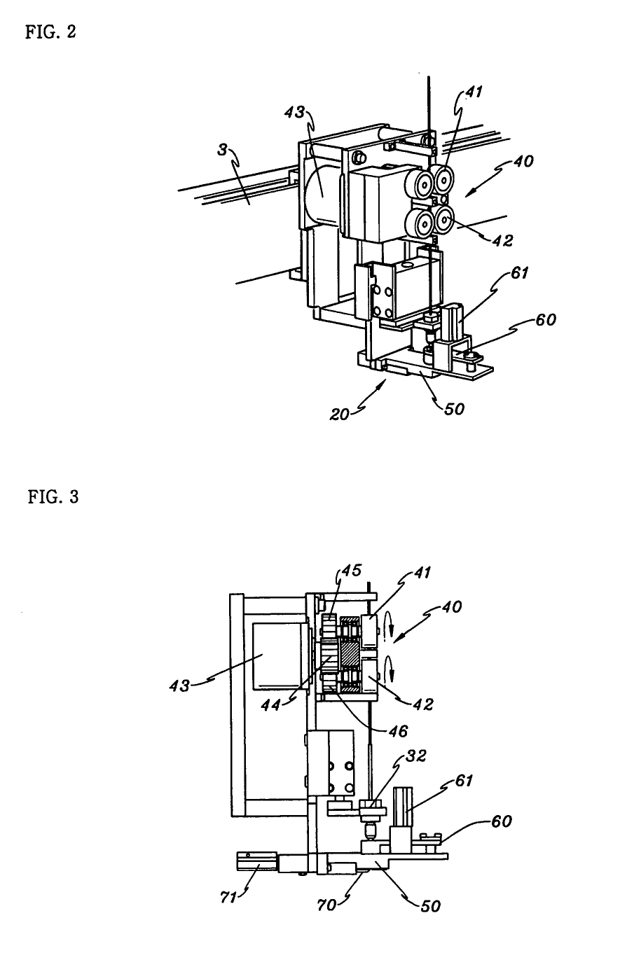

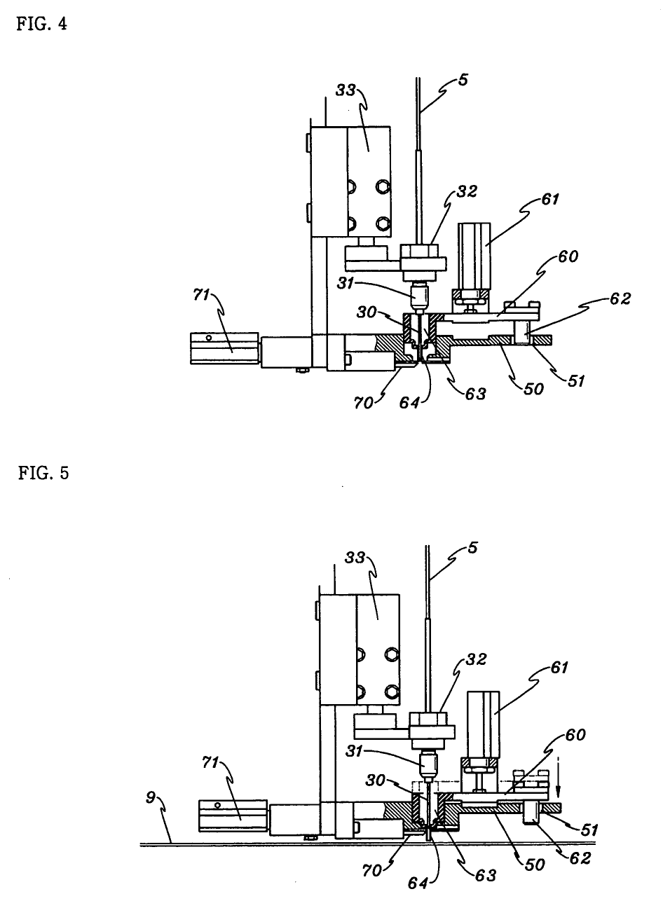

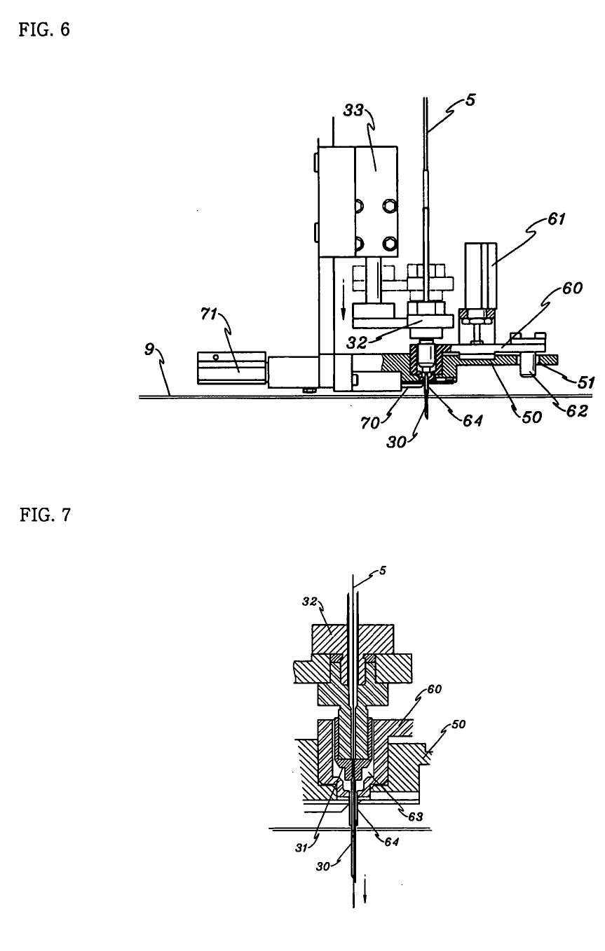

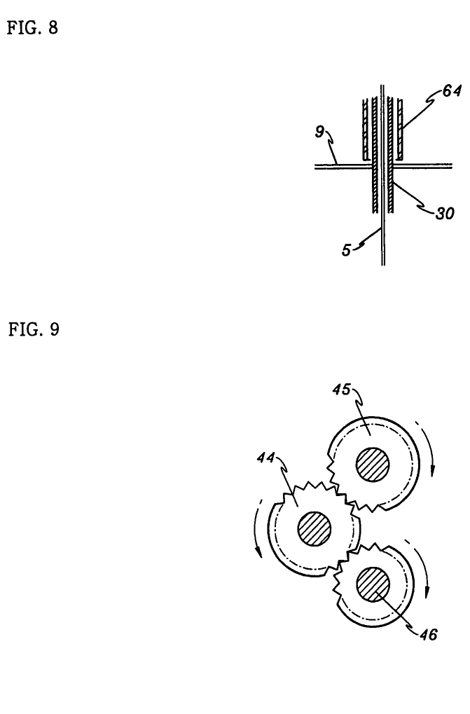

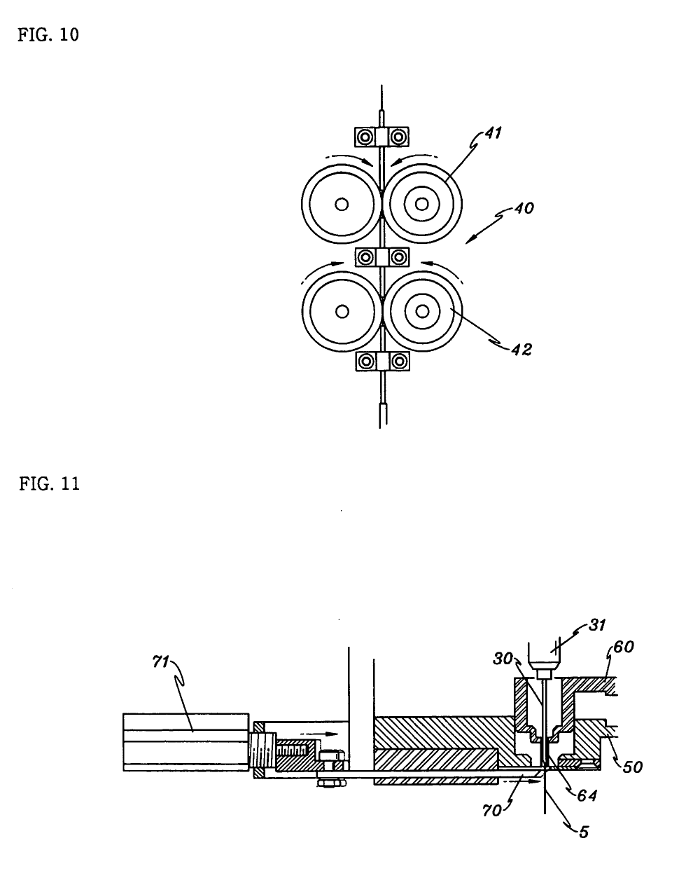

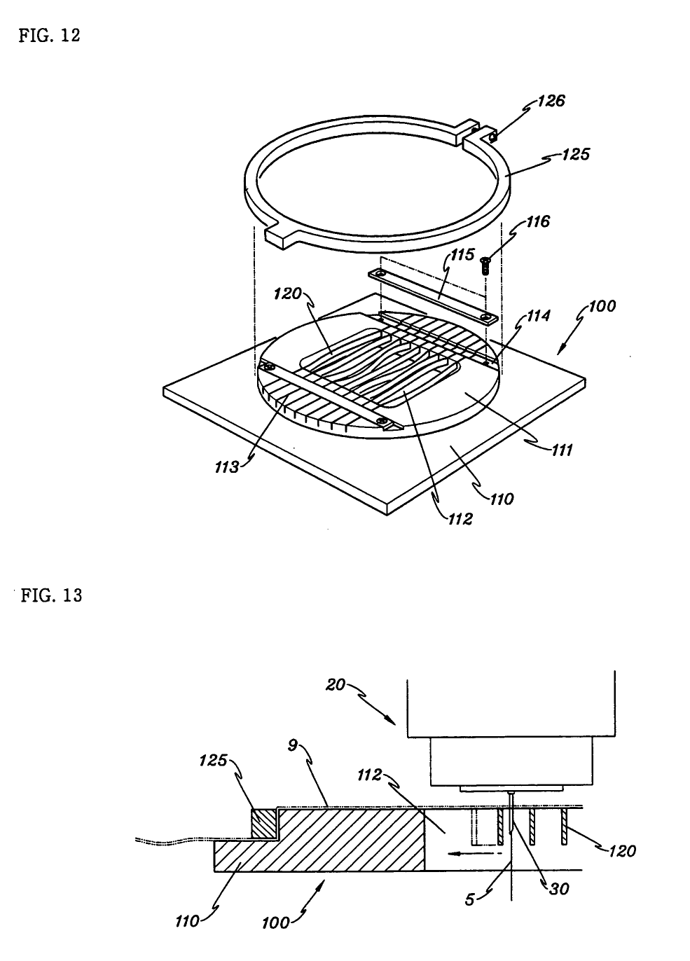

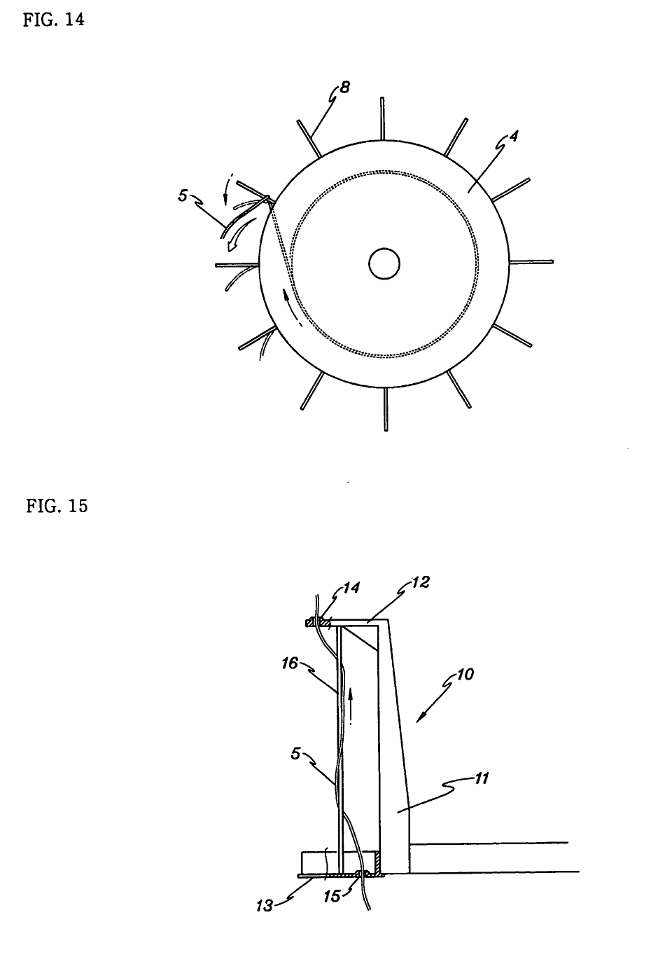

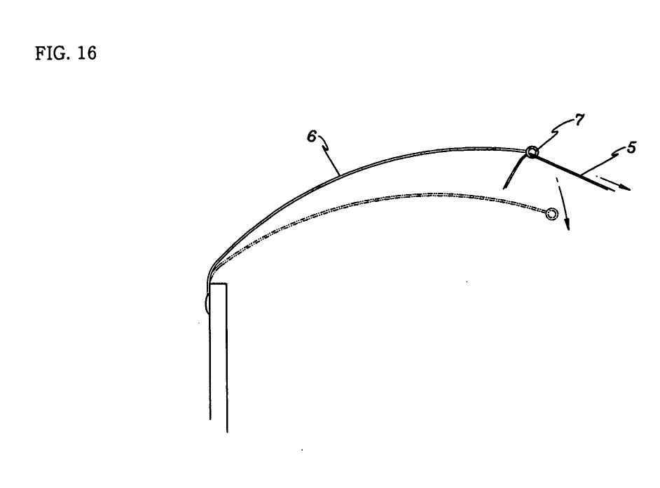

FIGS. 1 through 17 show diagram which illustrate the optical fiber sewing apparatus and the methods of manufacturing the products according to the present invention.

The detailed description concerning the constructions and functions of the present invention which is not essential to understanding of the subject matter of the present invention was omitted.

The following is a detailed explanation through examples of the invention. It should be understood, however, that the detailed description and specific examples are given by way of illustration only, since various changes and modifications within the spirit and scope of the invention will become apparent to those skilled in the art from this detailed description.

First of all, the sewing apparatus according to the present invention comprises a X axis fixed rod 2 on the upper section of a fixed table 1 in order to allow a Y axis table 3 to move along the X axis fixed rod 2 in X direction, and a sewing head 20 is located on a Y axis table and moves in Y direction, and a material workpiece 9 located below the head 20 is sewed with optical fibers 5 by the sewing head 20 which could move freely to X and Y directions.

The sewing head 20 comprises a needle transfer cylinder 33 that moves the needle 33 with an eye up and down directions, a sewing head 20 further comprises a transfer roller 40 which provides a fixed length of optical fibers 5 to the eye of the needle, and a fixed plate 50 which is fixed to the lower section of said sewing head 20, and a pushing plate 60 which is fixed on the upper section of said fixed plate 50 wherein said pushing plate 60 is moved up and down by a pushing plate transfer cylinder 61, and said pushing plate further comprises a insertion groove 63 to which a needle holder 31 is inserted and a guide pipe 64 is constructed at the lower section of said insertion groove 63.

A cutter 70 which cuts the optical fibers 5 is located at the lower section of said fixed plate 50 wherein said cutter 70 moves on a horizontal direction by a cutter cylinder 71 in order to cut the optical fibers 5.

The transfer roller 40 that provides the optical fiber 5 has a pair of upper section rollers 41 and a pair of lower section rollers 42. These are constructed below the upper section rollers 41, and the upper section rollers 41 and lower section rollers 42 are constructed in such a way that they are in contact with each other, and the optical fibers are provided by the upper section rollers 41 and lower section rollers 42 which are rotated by the rotation of roller gears 45, 46, and the roller gears 45, 46 are combined with a motor gear 44 which is rotated by a motor 43, in effect, the motor rotates the transfer roller 40.

Here, the rotation speed of the upper section rollers 41 should be faster than the rotation speed of the lower section rollers 42 during the provision of the optical fibers 5.

In order to provide a fixed length of optical fibers 5 at each time during the provision of the optical fibers 5 from the optical fiber spool 4 to the eye of the needle 30 requires a construction which comprises, a unreel protection optical fibers 8 located radially from the side face of the optical fiber spool 4 which prevents an excessive unreeling of the optical fibers, a tension control section 10 which controls the tension of the optical fibers while the optical fibers are whirling around a vertical rod 16, an elastic body 6 which allows the provision of a fixed length optical fibers 5 by applying tension to the optical fibers 5, a transfer roller 40 which provides the optical fibers 5 to the eye of the needle 30 after the optical fibers 5 pass through the elastic body 6, and an air supply hole which accommodates a smooth transfer of the optical fibers 5 provided by the transfer roller 40 towards the supply direction of the optical fibers.

Here, the tension control section 10 has an upper stand 12 and lower stand 13 on both upper and lower sections of a fixed board 11 and a vertical rod is constructed between the upper stand 12 and lower stand 13, and the optical fibers are provided through the upper and lower section holes 14, 15 by forming the upper and lower section holes 14, 15, and the optical fibers 5 are provided while whirling once around a vertical rod 16, and the elastic body, which is made of steel or spring which is in tension, and a hole 7, which the optical fibers are inserted, is constructed in order to unreel the optical fibers 5 through the tension generated by the elastic body 6 that moves down and returns again to the original position according to the passing speed of the optical fibers.

According to the present invention, a needle damper 32 is constructed on the sewing head 20 in such a way that the needle damper 32 moves by the operation of a needle transfer cylinder 33, and the needle 30 with an eye is inserted to the needle holder 31 at the lower section of the needle damper 32, and the optical fiber 5 is provided to the eye of the needle 30 by the transfer roller 40.

A pushing plate 60 is constructed on a fixed plate 50 which is fixed at the lower section of the sewing head 20 in such a way that the pushing plate 60 is moved up and down by a transfer cylinder 61, and at one side of the pushing plate 60 forms an insertion hole 63 where the needle holder 31 is inserted and at the other side forms a guide rod 62 which is inserted to a guide hole 51 of the fixed plate 50.

In this case, a guide pipe 64 is constructed at the lower section of the insertion groove 6 of the pushing plate 60 in such a way that the needle 30 moves through the inside of the guide pipe 64, and a cutter 70 is constructed at the lower section of the fixed plate 50, and the cutter 70 could move up and down by a cutter cylinder 71 in order to cut the optical fibers by exposing a fixed length of the optical fibers above the material workpiece.

A material workpiece support 100 that supports the material workpiece on which the needle 30 pierces comprises, a supporting board 111 which protrudes from the inside of the fixed plate 110, a sewing hole 112 which is constructed inside of the supporting board 111, a plurality of supporting blades 120 which crosses the sewing hole 112, and the supporting blades 120 are fixed by inserting a fixed lock 115 to a biding groove 114 and screwing them together.

Here, it is preferable to use a thin steel plate for the supporting blades 120, and a plurality of supporting blades 120 are inserted to insertion grooves 113 across the sewing hole 112 while the blades are facing upwards in order to support the material workpiece 9, and on the outside of the supporting board 111, a fixture 125 with a clamp 126 is inserted in order to hold the material workpiece 9 firmly.

The moving method of the sewing head 20 which moves in X and Y directions along the X axis fixing rod 2 and Y axis table 3 is already disclosed in the prior art, hence, a detailed description of the movement of the sewing head will be omitted and only the description about sewing of the optical fibers on the material workpiece 9 and cutting the optical fibers when the sewing head is in place will be given here.

When the sewing head 20 reaches a required position which is preprogrammed, the pushing plate 60 is lowered by operating a pushing plate transfer cylinder 61.

When the pushing plate 60 is lowered, the guide pipe 64 penetrates the fixed plate 50 and pushes down the material workpiece 9, in this instance, the guide rod moves along the guide hole 51 on the fixed plate 50 in order to prevent the movement of the pushing plate when it moves up and down.

When the pushing plate 60 is lowered and the upper section of the material workpiece 9 is being pushed down, a needle clamp 32 is lowered by the cylinder 33 and the needle holder 31 is inserted to the inserting groove 63 of the pushing plate 60 in order for the needle 30 to pierce the material workpiece 9 through the guide pipe 64.

In this instance, the material workpiece 9 is fixed on the upper section of the supporting blades 120 of the material workpiece table 100, as a result, the material workpiece does not move while the needle 30 is piercing through it and the needle 30 can pierce on the exactly required position on the material workpiece 9.

When the front end of the needle 30 touches on the upper section of the supporting blades 120 during the piercing of the material workpiece 9, the needle can bend either left or right of the supporting blades 120 along the slope of the needle 30, as a result, the needle never hits on the upper section of the supporting blades 120.

Hence, the material workpiece 9 does not get crumpled and the needle never hits on the upper section of the supporting blades 120, resulting the needle 30 to pierce through the exactly required position on the material workpiece 9 and prevent it from any damages.

Likewise, when the needle 30 pierces the material workpiece 9 which is located on the material workpiece table 100, the transfer roller 40 which is consisted a upper section roller 41 and lower section roller 42 is operated to provide the optical fibers to the eye of the needle in which the optical fiber originating from the spool 4 passes through the elastic body 6 after whirling round the vertical rod 16.

In this instance, the optical fiber originating from the spool 4 is protected from an excessive unreeling by unreel protection optical fibers 8, hence, no tangling up occurs. The optical fibers unreeled from the spool 4 is provided to the transfer roller 40 after whirling around the vertical rod 16 of the tension control section 10 and passing through a hole 7 of the elastic body 6. As a result, even if an excessive amount of pulling occurs on the optical fibers 5, the optical fibers 5 are not excessively supplied but only the amount which was provided to the eye of the needle 30 will be provided. Also, when the optical fibers 5 are pulled excessively, no excessive unreeling or loosening would occur from the spool 4.

The unreeled optical fibers 5 from the tension control section 10 is provided through a hole at the front end of the elastic body 6. The elastic body 6 moves down by the tension on the optical fibers 5 when the provision of the optical fibers starts and it returns to its original position when the provision of the optical fibers stops. When the elastic body 6 returns, the optical fibers 5 are unreeled from the spool 4 in such a way that a fixed amount of tension is generated on the optical fibers 5.

The moving distance of the optical fibers 5, which is provided to the eye of the needle 30, depends on the total number of rotations of the transfer roller 40. The rotation speed of the upper section rollers 41 should be faster than the rotation speed of the lower section rollers 42 so that the lower section rollers 42 pulls the optical fibers from the upper section rollers 41 in order to prevent a slip and to provide a fixed length of the optical fibers all the time. The optical fibers 5 are pushed down at two points in order to prevent a reverse slip when the elastic body returns to its original position.

Here, since the rotation speed of the upper section rollers 41 should be faster than the rotation speed of the lower section rollers 42, as a result, the lower section rollers 42 pulls the optical fibers from the upper section rollers 41 and the optical fibers 5 are provided according to the total number of rotation of the upper section rollers 41. A smooth transfer of the optical fibers 5, which is provided by the lower roller 40, towards the supply direction of the optical fibers is accomplished.

As described so far, after the optical fibers are provided to the eye 5 of the needle 30, the needle is pulled upwards by the cylinder 33.

In this instance, when the needle which has pierced the material workpiece 9 is pulled upwards, the material workpiece 9 might be lifted together, however, the guide pipe 64 is pushing down the material workpiece 9, as a result, the material workpiece 9 remains on the table and only the needle 30 is pulled upwards to its original position.

When the transfer cylinder 61 of the pushing plate is operated after the needle 30 is pulled upwards to its original position, the pushing plate 60 is lifted and the guide pipe 64 is separated from the material workpiece 9 and returns to the upper side of the cutter 70.

Also, when the cutter cylinder 71 is operated, the cutter moves to the optical fibers 5 side and cuts the optical fibers 5 in such a way that a fixed length of the optical fibers 5 remains from the upper section of the material workpiece 9.

A single round of sewing of the optical fibers 5 is completed when the optical fibers 5 is cut. By moving the position of the sewing head 20 and repeating the above processes, a required pattern or letter design which is sewed on the material workpiece 9 is obtained.

The products are manufactured using the optical fiber sewing apparatus according to the present invention, by sewing an arbitrary character shape on a rubber material workpiece with optical fibers, and one end of each optical fiber is connected to a number of LEDs with various colors, and when a switch is operated, LED emits light due to the wiring operation of a electronic chip powered by a battery.

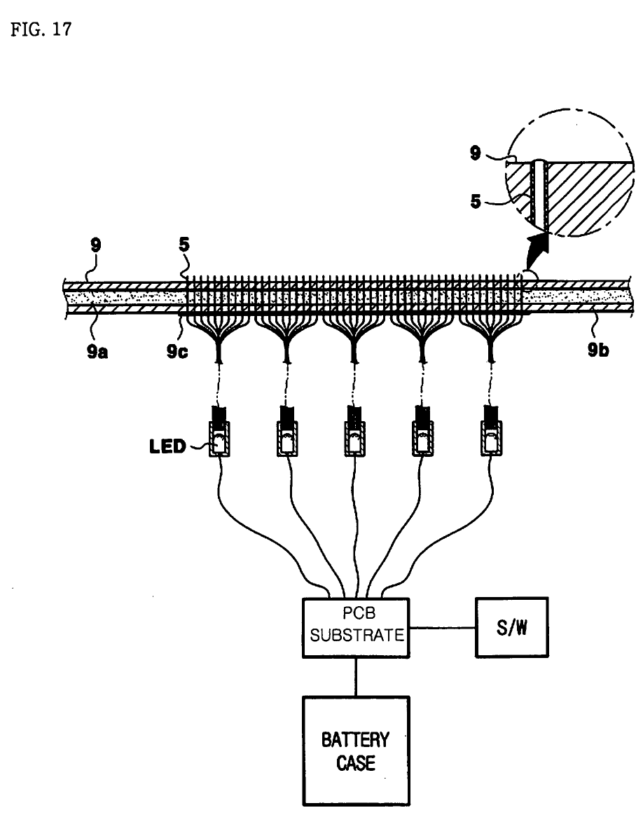

As shown in FIG. 17, the products are completed after going through the steps, comprising; sewing with optical fibers after a material workpiece 9, rubber 9a and inside material 9b are sequentially attached together, forming a UV coating layer 9c in order to fix the optical fibers 5 which are sewed onto the inside material 9b; cutting short the optical fibers 5 which are protruding from the material workpiece 9, and heating the end of the optical fibers 5 which have been cut with a heater at 400-500° C. for 1 to 2 seconds in order to form a smooth curve.

Some of the products which are manufactured using the optical fiber sewing apparatus according to the present invention might include home fashion products, toys, advertisement materials, accessories, plaques, caps, bags, clothes, etc.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

According to the above detailed description of the present invention, when the needle, which has pierced the material workpiece, is pulled upwards, the material workpiece might be lifted together, however, the guide pipe is pushing down the material workpiece, as a result, the material workpiece remains on the table and only the needle is pulled upwards to its original position.

Also, a fixed length of optical fibers which pierce through a material workpiece, is maintained by maintaining a fixed tension by a roller of the head after unreeled from a spool until the optical fibers are provided to the eye of a needle.

The crumpling of a material workpiece as well as damaging of the supporting blades or a needle is prevented by supporting the material workpiece with a plurality of supporting blades which are spaced apart at a fixed length on a thin plate underneath the material workpiece and allowing the supporting blades to bend to left or right in order to avoid blocking of the needle when the needle touches the supporting blades.

What is claimed is:

1. An optical fiber sewing apparatus according to the present invention wherein said apparatus comprises a needle transfer cylinder 33 that moves the needle 33 with an eye up and down directions, a sewing head 20 that further comprises a transfer roller 40 which provides a fixed length of optical fibers through the eye of the needle and moves in X and Y directions, an improvement of said apparatus, comprising;
a fixed plate 50 which is fixed to the lower section of said sewing head 20;
a pushing plate 60 which is fixed on upper section of said fixed plate 50 wherein said pushing plate 60 is moved up and down by a pushing plate transfer cylinder 61 and said pushing plate further comprises a insertion groove 63 to which a needle holder 31 is inserted and a guide pipe 64 is constructed at the lower section of said insertion groove 63;
a cutter 70 which cuts the optical fibers 5 and located at the lower section of said fixed plate 50 wherein said cutter 70 moves on a horizontal direction by a cutter cylinder 71 in order to cut the optical fibers 5;
a material workpiece table 100 which is located at the lower section of said cutter 70 in order to support a material workpiece 9 with a plurality of supporting blades 120; and wherein said optical fibers 5 is provided through the eye of the needle 30 from a optical fiber spool via a tension control section 10 and elastic body 6.

2. The apparatus as claimed in claim 1, wherein said pushing plate 60 moves up and down on the upper section of fixed plate 50 and said guide pipe 64 penetrates the fixed plate 50 and pushes down the upper section of the material workpiece 9.

3. The apparatus as claimed in claim 1, wherein said needle with an eye pierces the material workpiece 9 through the inside of the guide pipe 64.

4. The apparatus as claimed in claim 1, further comprising unreel protection optical fibers 8 which are located radially from the side face of said optical fiber spool 4 which prevents an excessive unreeling of the optical fibers.

5. The apparatus as claimed in claim 1, wherein said tension control section 10 further comprises a upper and lower supports 12, 13 at the upper and lower section of the fixed board 11 and said upper and lower supports further comprises a fixed vertical rod 16 and a upper and lower holes 14, 15 through which the optical fibers 5 passes, and said optical fibers 5 are provided while said optical fibers are whirled around the said vertical rod.

6. The apparatus as claimed in claim 1, wherein said the optical fibers 5 are provided by a pair of upper section rollers 41 and a pair of lower section rollers 42 and the rotation speed of said upper section rollers 41 should be faster than the rotation speed of said lower section rollers 42 during the provision of the optical fibers 5.

7. The apparatus as claimed in claim 1, wherein said material workpiece support 100 further comprising:
a fixed plate 110;
a supporting board 111 which protrudes from the inside of said fixed plate 110;
a sewing hole 112 which is constructed inside of said supporting board 111; and
a plurality of board shape supporting blades 120 which are constructed across said sewing hole 112.

8. A method of manufacturing products using an optical fiber sewing apparatus, comprising the steps of:
sewing with optical fibers after a material workpiece 9, rubber 9a and inside material 9b are sequentially attached together;
forming a UV coating layer 9c in order to fix the optical fibers 5 which are sewed onto the inside material 9b; cutting short the optical fibers 5 which are protruding from the material workpiece 9; and
heating the end of the optical fibers 5 which have been cut with a heater at 400-500° C. for 1 to 2 seconds in order to form a smooth curve.
